(19) United States
(12) Patent Application Publication
(10) Pub. No.: US 2023/0182524 A1
(43) Pub. Date: Jun. 15, 2023

(54) BATTERY COOLING SYSTEM OF VEHICLE

(71) Applicants: Hyundai Motor Company, Seoul (KR); Kia Corporation, Seoul (KR)

(72) Inventors: Seung Woo Yang, Goyang (KR); Yeon Man Jeong, Yongin, Gyeonggi-do (KR)

(21) Appl. No.: 17/894,644

(22) Filed: Aug. 24, 2022

(30) Foreign Application Priority Data
Dec. 15, 2021 (KR) 10-2021-0179800

(51) Int. Cl. B60H 1/00; H01M 10/613; H01M 10/625; H01M 10/6568

(52) U.S. Cl. CPC B60H 1/00278; B60H 1/00885; H01M 10/613; H01M 10/625; H01M 10/6568; H01M 2220/20

(57) ABSTRACT

Provided is a battery cooling system of a vehicle, the battery cooling system including: a battery, a battery chiller connected to the battery, a first pump mounted such that a refrigerant cooled at the battery chiller is circulated to the battery, a radiator mounted such that the radiator is connected to or disconnected from the battery, a second pump mounted such that the refrigerant cooled at the radiator is circulated to the battery, and a switching valve provided to switch a state in which a refrigerant inlet and a refrigerant outlet of the battery are respectively connected to a refrigerant outlet and a refrigerant inlet of the radiator, and a state in which the battery is disconnected from the radiator and only the refrigerant cooled at the battery chiller is circulated to the battery.

### CROSS REFERENCE TO RELATED APPLICATION

The present application is based on and claims under 35 U.S.C. § 119(a) priority to Korean Patent Application No. 10-2021-0179800, filed Dec. 15, 2021, the entire contents of which are incorporated herein for all purposes by this reference.

### BACKGROUND

### Technical Field

Embodiments of the present disclosure relate to a technology of cooling a battery mounted in an electric vehicle and the like.

### Description of the Related Art

As a driving distance of recent electric vehicles increases, batteries mounted in the electric vehicles also have been gradually developed to have high specifications and, accordingly, battery cooling systems are also changing from a conventional air-cooled type to a water-cooled type.

It is preferable that the water-cooled type battery cooling system as described above has a simple configuration and is lightweight, and also can realize cooling of a battery with high efficiency.

### SUMMARY

Accordingly, embodiments of the present disclosure have been made keeping in mind the above problems occurring in the related art, and an objective of embodiments of the present disclosure is to provide a battery cooling system of a vehicle, the battery cooling system being capable of reducing the number of required components by having a simple configuration, and the battery cooling system being capable of largely increasing cooling efficiency, thereby, ultimately, being capable of increasing electric efficiency of the vehicle.

In order to achieve the objective of embodiments of the present disclosure, there is provided a battery cooling system of a vehicle, the battery cooling system including: a battery; a battery chiller connected to the battery; a first pump mounted such that a refrigerant cooled at the battery chiller is circulated to the battery; a radiator mounted such that the radiator is connected to or disconnected from the battery; a second pump mounted such that the refrigerant cooled at the radiator is circulated to the battery; and a switching valve provided to switch a state in which a refrigerant inlet and a refrigerant outlet of the battery are respectively connected to a refrigerant outlet and a refrigerant inlet of the radiator, and a state in which the battery is disconnected from the radiator and only the refrigerant cooled at the battery chiller is circulated to the battery.

In addition, the battery, the battery chiller, and the first pump may configure a first cooling circuit that is a closed circuit through which the refrigerant passes and circulates, the radiator and the second pump may configure a second cooling circuit that is a closed circuit through which the refrigerant passes and circulates, the switching valve may connect the first cooling circuit and the second cooling circuit such that the first cooling circuit and the second cooling circuit are integrated, thereby forming the state in which the refrigerant inlet and the refrigerant outlet of the battery are respectively connected to the refrigerant outlet and the refrigerant inlet of the radiator, and the switching valve may separate the first cooling circuit and the second cooling circuit from each other, thereby disconnecting the battery from the radiator and forming the state in which only the refrigerant cooled at the battery chiller is circulated to the battery.

In addition, the switching valve may include: a first port connected to a refrigerant inlet side of the battery; a second port connected to a refrigerant outlet side of the battery; a third port connected to a refrigerant outlet side of the radiator; and a fourth port connected to a refrigerant inlet side of the radiator, wherein the switching valve may be configured to switch a state in which the first port and the second port are in communication with each other and the third port and the fourth port are in communication with each other, thereby separating the first cooling circuit and the second cooling circuit from each other, and a state in which the first port and the third port are in communication with each other and the second port and the fourth port are in communication with each other, thereby connecting and integrating the first cooling circuit and the second cooling circuit with each other.

In addition, the first cooling circuit may further include a temperature raising heater.

In addition, the second cooling circuit may further include a water-cooled condenser and a reservoir tank.

In addition, the water-cooled condenser may be provided at an upstream point of the radiator, and the reservoir tank may be provided at a downstream point of the radiator.

In addition, in order to achieve the objective of embodiments of the present disclosure, there is provided a battery cooling system of a vehicle, the battery cooling system including: a first cooling circuit configuring a closed circuit of a refrigerant, the closed circuit including a battery and a battery chiller; a second cooling circuit configuring a closed circuit of the refrigerant, the closed circuit including a radiator; and a switching valve provided to switch a state in which the first cooling circuit and the second cooling circuit are separated from each other and are independent from each other, and a state in which the first cooling circuit and the second cooling circuit are connected to each other and are integrated.

In addition, the first cooling circuit may further include a first pump circulating the refrigerant cooled at the battery chiller and a temperature raising heater that is capable of increasing the temperature of the refrigerant.

In addition, the battery, the temperature raising heater, the battery chiller, and the first pump may be sequentially disposed in the first cooling circuit.

In addition, the second cooling circuit may further include a reservoir tank storing the refrigerant passing through the radiator and a second pump circulating the refrigerant passing through the radiator.

In addition, the radiator, the reservoir tank, and the second pump may be sequentially disposed in the second cooling circuit.

In addition, a water-cooled condenser may be further provided at an upstream point of the radiator.

In addition, the switching valve may include: a first port connected to a refrigerant inlet side of the battery; a second port connected to a refrigerant outlet side of the battery; a third port connected to a refrigerant outlet side of the radiator; and a fourth port connected to a refrigerant inlet side of the radiator, wherein the switching valve is configured to switch a state in which the first port and the second port are in communication with each other and the third port and the fourth port are in communication with each other, thereby separating the first cooling circuit and the second cooling circuit from each other, and a state in which the first port and the third port are in communication with each other and the second port and the fourth port are in communication with each other, thereby connecting and integrating the first cooling circuit and the second cooling circuit with each other.

In addition, the first pump provided to circulate the refrigerant of the first cooling circuit may be disposed between the switching valve and the battery, and the second pump provided to circulate the refrigerant of the second cooling circuit may be disposed between the switching valve and the radiator.

In addition, at least one of the first pump that is provided to circulate the refrigerant of the first cooling circuit and the second pump that is provided to circulate the refrigerant of the second pump may be formed integrally with the switching valve.

In embodiments of the present disclosure, the number of components required for the battery cooling system can be reduced by having the simple configuration, the weight of the vehicle can be reduced, and the cooling efficiency can be largely increased, thereby, ultimately, increasing the electric efficiency of the vehicle.

As discussed, the system suitably includes use of a controller or processer.

In another embodiment, vehicles are provided that comprise an apparatus as disclosed herein.

### BRIEF DESCRIPTION OF THE DRAWINGS

The above and other objectives, features, and other advantages of embodiments of the present disclosure will be more clearly understood from the following detailed description when taken in conjunction with the accompanying drawings, in which:

FIG. 1 is a view illustrating a configuration of a battery cooling system of a vehicle according to the present disclosure;

FIG. 2 is a view illustrating a refrigerant flow in a state in which a first cooling circuit and a second cooling circuit of the battery cooling system in FIG. 1 are integrally connected to each other;

FIG. 3 is a view illustrating a state of a switching valve in the same state as in FIG. 2;

FIG. 4 is a view illustrating the refrigerant flow in a state in which the first cooling circuit and the second cooling circuit of the battery cooling system in FIG. 1 are independently separated from each other; and

FIG. 5 is a view illustrating a state of the switching valve in the same state as in FIG. 4.

### DETAILED DESCRIPTION

Specific structural or functional descriptions of the embodiments of the present disclosure disclosed in the present specification are exemplified only for the purpose of describing the embodiments according to the present disclosure, and the embodiments according to the present disclosure may be implemented in various forms and should not be construed as being limited to the embodiments described in the present specification.

Since the embodiments according to the present disclosure can be modified in various ways and have various forms, specific embodiments are illustrated in the drawings and will be described in detail in the present specification. However, this is not intended to limit the embodiments according to the concept of the present disclosure to a specific form of disclosure, and it should be understood that all changes, equivalents, and substitutes included in the spirit and scope of the present disclosure are included.

Terms such as first and/or second may be used to describe various components, but the components should not be limited by the terms. The above terms are only for the purpose of distinguishing one component from other components, for example, without departing from the scope of the rights according to the concept of the present disclosure, the first component may be referred to as the second component, and similarly the second component may also be referred to as a first component.

When a component is referred to as being “connected” or “contacted” to another component, it should be understood that it may be directly connected or contacted to the other component, but other components may exist therebetween. On the other hand, when a component is referred to as being “directly connected” or “directly contacted” to another component, it should be understood that there is no other component in the middle. Other expressions describing the relationship between components, such as “between” and “just between” or “adjacent to” and “directly adjacent to” should be interpreted as well.

The terms used in the present specification are only used to describe specific embodiments and are not intended to limit the present disclosure. Singular expressions include plural expressions unless the context clearly indicates otherwise. In the present specification, terms such as “comprise” or “have” are intended to designate the presence of a set feature, number, step, action, component, part, or combination thereof, but it should be understood that the presence or additional possibilities of one or more other features, numbers, steps, actions, components, parts, or combinations thereof are not preliminarily excluded.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise defined, all terms used herein, including technical or scientific terms, have the same meaning as commonly understood by one of ordinary skill in the art to which the present disclosure belongs. Terms such as those defined in a commonly used dictionary should be interpreted as having a meaning consistent with the meaning of the related technology and should not be interpreted as an ideal or excessively formal meaning unless explicitly defined in the present specification.

Hereinafter, the present disclosure will be described in detail by describing a preferred embodiment of the present disclosure with reference to the accompanying drawings. The same reference numerals shown in each drawing indicate the same members.

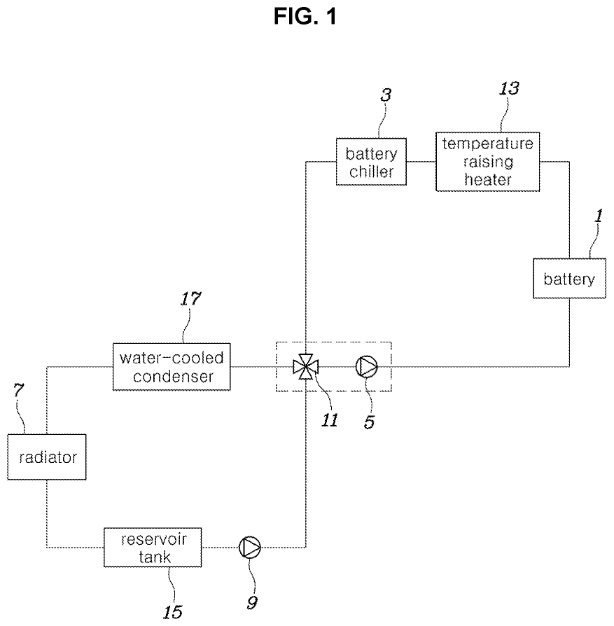

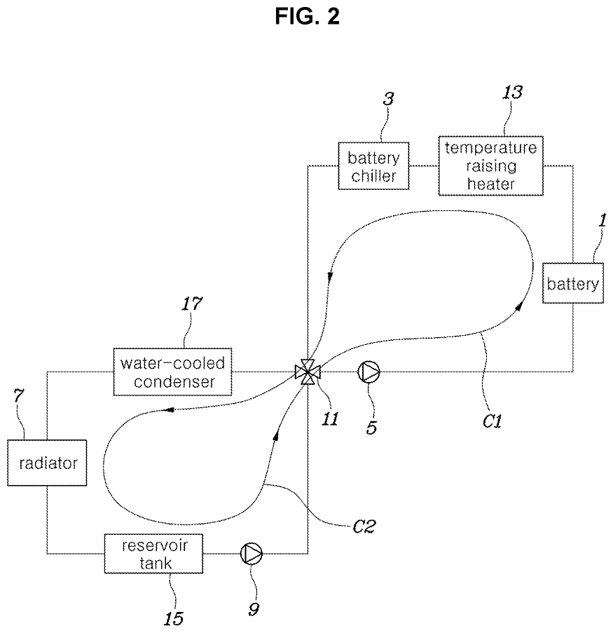

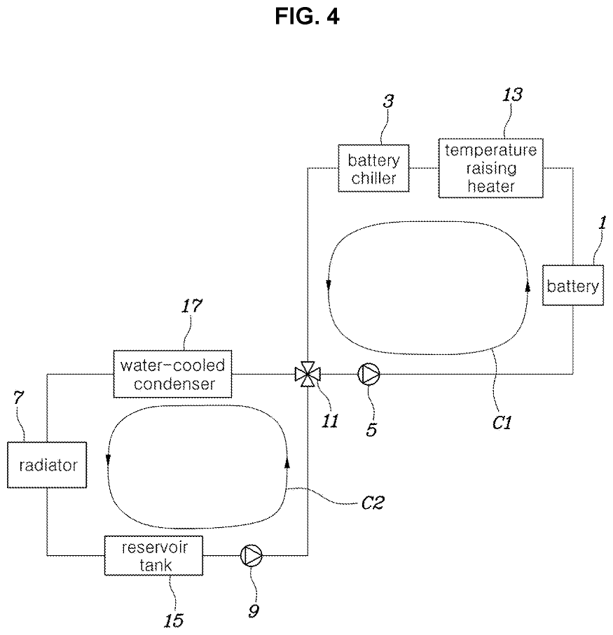

Referring to FIGS. 1 to 5, a battery cooling system of a vehicle may include: a battery 1; a battery chiller 3 connected to the battery 1; a first pump 5 mounted such that a refrigerant cooled at the battery chiller 3 is circulated to the battery 1; a radiator 7 mounted such that the radiator 7 is connected to or disconnected from the battery 1; a second pump 9 mounted such that the refrigerant cooled at the radiator 7 is circulated to the battery 1; a switching valve 11 provided to switch a state in which a refrigerant inlet and a refrigerant outlet of the battery 1 are respectively connected to a refrigerant outlet and a refrigerant inlet of the radiator 7, and a state in which the battery 1 is disconnected from the radiator 7 and only the refrigerant cooled at the battery chiller 3 is circulated to the battery 1.

Here, the battery 1, the battery chiller 3, and the first pump 5 may configure a first cooling circuit C1 that is a closed circuit through which the refrigerant passes and circulates, and the radiator 7 and the second pump 9 may configure a second cooling circuit C2 that is a closed circuit through which the refrigerant passes and circulates.

The switching valve 11 may connect the first cooling circuit C1 and the second cooling circuit C2 so that the first cooling circuit C1 and the second cooling circuit C2 are integrated, thereby forming the state in which the refrigerant inlet and the refrigerant outlet of the battery 1 are respectively connected to the refrigerant outlet and the refrigerant inlet of the radiator 7. Further, the switching valve 11 may disconnect the first cooling circuit C1 and the second cooling circuit C2 from each other, thereby forming the state in which the battery 1 is disconnected from the radiator 7 and only the refrigerant cooled at the battery chiller 3 may be circulated to the battery 1.

That is, embodiments of the present disclosure include: the first cooling circuit C1 forming the closed circuit of the refrigerant, the closed circuit including the battery 1 and the battery chiller 3; the second cooling circuit C2 forming the closed circuit of the refrigerant, the closed circuit including the radiator 7; and the switching valve 11 provided to switch a state in which the first cooling circuit C1 and the second cooling circuit C2 are independently separated from each other, and a state in which the first cooling circuit C1 and the second cooling circuit C2 are connected to each other and are integrated.

Therefore, in conditions such as winter, in which heat-dissipation of the radiator 7 is easily performed, the refrigerant may be circulated in the state in which the first cooling circuit C1 and the second cooling circuit C2 are connected to each other and are integrated by using the switching valve 11, and the radiator 7 may be utilized to form a cooled state of the battery 1 by using the switching valve 11. Further, in conditions such as summer, in which the radiator 7 is difficult to dissipate heat, the first cooling circuit C1 may be configured to be independent from the second cooling circuit C2 by using the switching valve 11, and the refrigerant cooled at the battery chiller 3 may only circulate to the first cooling circuit C1 and the refrigerant may cool the battery 1, so that the battery 1 is efficiently cooled.

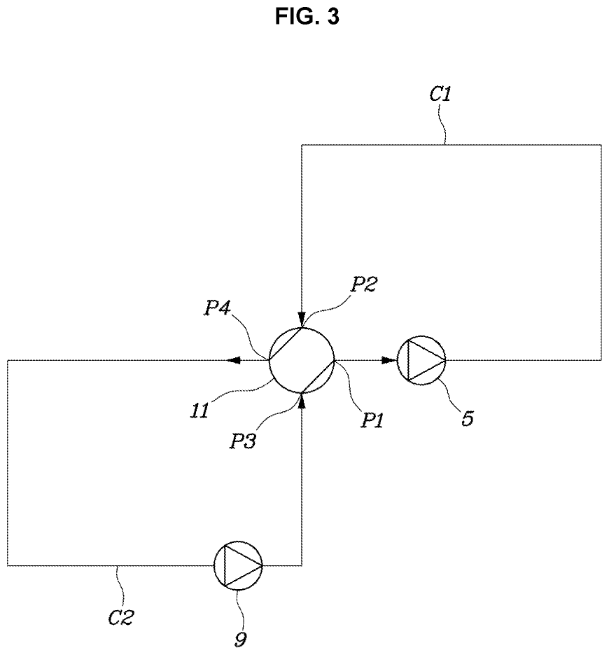

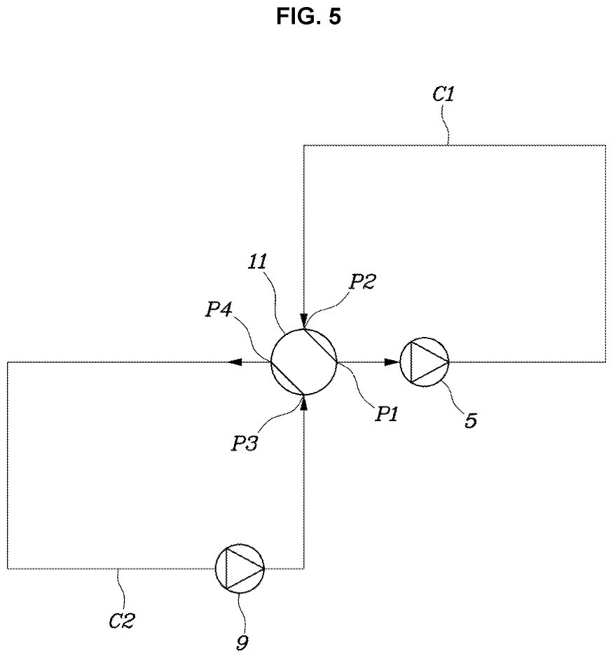

The switching valve 11 may include: a first port P1 connected to a refrigerant inlet side of the battery 1; a second port P2 connected to a refrigerant outlet side of the battery 1; a third port connected to a refrigerant outlet side of the radiator 7; and a fourth port P4 connected to a refrigerant inlet side of the radiator 7. Further, the switching valve 11 is configured such that the switching valve 11 switches a state in which the first port P1 and the second port P2 are in communication with each other and the third port P3 and the fourth port P4 are in communication with each other, thereby separating the first cooling circuit C1 and the second cooling circuit C2 from each other as illustrated in FIG. 5, and a state in which the first port P1 and the third port P3 are in communication with each other and the second port P2 and the fourth port P4 are in communication with each other, thereby connecting and integrating the first cooling circuit C1 and the second cooling circuit C2 with each other as illustrated in FIG. 3.

That is, the switching valve 11 may be a four-way valve that is configured to switch the state illustrated in FIG. 3 and the state illustrated in FIG. 5, according to a movement of a valve spool.

Meanwhile, the first cooling circuit C1 may be configured such that the battery 1, a temperature raising heater 13, the battery chiller 3, and the first pump 5 are sequentially disposed.

The temperature raising heater 13 may be mounted so as to heat the refrigerant when the temperature of the battery 1 is required to be raised.

In addition, the second cooling circuit C2 may be configured such that the radiator 7, a reservoir tank 15, and the second pump 9 are sequentially disposed, and a water-cooled condenser 17 is further provided at an upstream point of the radiator 7.

The water-cooled condenser 17 may be configured such that the refrigerant of the battery chiller 3 and a refrigerant used for cooling a driving motor of the vehicle can exchange heat with the refrigerant flowing through the second cooling circuit C2.

Here, the first pump 5 provided to circulate the refrigerant of the first cooling circuit C1 may be disposed between the switching valve 11 and the battery 1, and the second pump 9 provided to circulate the refrigerant of the second cooling circuit C2 may be disposed between the switching valve 11 and the radiator 7.

Therefore, in a state in which the first cooling circuit C1 and the second cooling circuit C2 are integrated by the switching valve 11 and are operated, the refrigerant of the reservoir tank 15 may be pressed by the second pump 9 and may be introduced into the switching valve 11, and the refrigerant that has passed through the switching valve 11 may be pressed again by the first pump 5 that is continuously disposed, so that a refrigerant flow that has been lowered while passing through the switching valve 11 is restored to a smooth state again. Finally, the refrigerant may circulate smoothly throughout the first cooling circuit C1 and the second cooling circuit C2, thereby largely contributing to the improvement of both cooling performance and cooling efficiency of the battery 1.

In addition, at least one of the first pump 5 that is provided to circulate the refrigerant of the first cooling circuit C1 and the second pump 9 that is provided to circulate the refrigerant of the second cooling circuit C2 may be formed integrally with the switching valve 11.

For reference, in FIG. 1, the dotted line box indicates that the switching valve 11 may be formed integrally with the first pump 5.

As described above, when the switching valve 11 is formed integrally with the first pump 5 or the second pump 9 or both the first pump 5 and the second pump 9, the number of components handled when the battery cooling system of the vehicle is assembled may be significantly reduced.

In the battery cooling system of embodiments of the present disclosure configured as described above, the battery 1 may be operated in an optimal temperature state since the refrigerant is circulated while heating or cooling the refrigerant according to a temperature state of the battery 1. Specifically, in environmental conditions where the radiator 7 is excellently dissipating heat, the first cooling circuit C1 and the second cooling circuit C2 may be integrated, thereby cooling the battery 1 by the refrigerant that is cooled by passing through the radiator 7. Further, in conditions in which the radiator 7 is dissipating heat with relatively low performance, the battery 1 may be cooled by the battery chiller 3 while being in the state in which the first cooling circuit C1 is separated from the second cooling circuit C2, thereby allowing an optimized cooling of the battery 1 according to changes in the environment around the vehicle to be realized.

In addition, the switching of the separation state and the integrated state of the first cooling circuit C1 and the second cooling circuit C2 as described above can be easily realized by the switching valve 11 that is the four-way valve. Therefore, the configuration and the control of the battery cooling system are simplified, and the weight of the battery cooling system is reduced. Further, the battery cooling system may contribute to the improvement of the electric efficiency of the vehicle.

Although exemplary embodiments of the present disclosure have been described herein, it is understood that the present disclosure should not be limited to these exemplary embodiments and that various changes and modifications can be made by one ordinary skilled in the art within the spirit and scope of the present disclosure.

What is claimed is:

1. A battery cooling system of a vehicle, the battery cooling system comprising:
a battery;
a battery chiller connected to the battery;
a first pump mounted such that a refrigerant cooled at the battery chiller is circulated to the battery;
a radiator mounted such that the radiator is connected to or disconnected from the battery;
a second pump mounted such that the refrigerant cooled at the radiator is circulated to the battery; and
a switching valve provided to switch a state in which a refrigerant inlet and a refrigerant outlet of the battery are respectively connected to a refrigerant outlet and a refrigerant inlet of the radiator, and a state in which the battery is disconnected from the radiator and only the refrigerant cooled at the battery chiller is circulated to the battery.

2. The battery cooling system of claim 1, wherein the battery, the battery chiller, and the first pump configure a first cooling circuit that is a closed circuit through which the refrigerant passes and circulates,
the radiator and the second pump configure a second cooling circuit that is a closed circuit through which the refrigerant passes and circulates,
the switching valve connects the first cooling circuit and the second cooling circuit such that the first cooling circuit and the second cooling circuit are integrated, thereby forming the state in which the refrigerant inlet and the refrigerant outlet of the battery are respectively connected to the refrigerant outlet and the refrigerant inlet of the radiator, and
the switching valve separates the first cooling circuit and the second cooling circuit from each other, thereby disconnecting the battery from the radiator and forming the state in which only the refrigerant cooled at the battery chiller is circulated to the battery.

3. The battery cooling system of claim 2, wherein the switching valve comprises:
a first port connected to a refrigerant inlet side of the battery;
a second port connected to a refrigerant outlet side of the battery;
a third port connected to a refrigerant outlet side of the radiator; and
a fourth port connected to a refrigerant inlet side of the radiator,
wherein the switching valve is configured to switch a state in which the first port and the second port are in communication with each other and the third port and the fourth port are in communication with each other, thereby separating the first cooling circuit and the second cooling circuit from each other, and a state in which the first port and the third port are in communication with each other and the second port and the fourth port are in communication with each other, thereby connecting and integrating the first cooling circuit and the second cooling circuit with each other.

4. The battery cooling system of claim 2, wherein the first cooling circuit further comprises a temperature raising heater.

5. The battery cooling system of claim 2, wherein the second cooling circuit further comprises a water-cooled condenser and a reservoir tank.

6. The battery cooling system of claim 5, wherein the water-cooled condenser is provided at an upstream point of the radiator, and the reservoir tank is provided at a downstream point of the radiator.

7. A battery cooling system of a vehicle, the battery cooling system comprising:
a first cooling circuit configuring a closed circuit of a refrigerant, the closed circuit comprising a battery and a battery chiller;
a second cooling circuit configuring a closed circuit of the refrigerant, the closed circuit comprising a radiator; and
a switching valve provided to switch a state in which the first cooling circuit and the second cooling circuit are separated from each other and are independent from each other, and a state in which the first cooling circuit and the second cooling circuit are connected to each other and are integrated.

8. The battery cooling system of claim 7, wherein the first cooling circuit further comprises a first pump circulating the refrigerant cooled at the battery chiller and a temperature raising heater that is capable of increasing the temperature of the refrigerant.

9. The battery cooling system of claim 8, wherein the battery, the temperature raising heater, the battery chiller, and the first pump are sequentially disposed in the first cooling circuit.

10. The battery cooling system of claim 7, wherein the second cooling circuit further comprises a reservoir tank storing the refrigerant passing through the radiator and a second pump circulating the refrigerant passing through the radiator.

11. The battery cooling system of claim 10, wherein the radiator, the reservoir tank, and the second pump are sequentially disposed in the second cooling circuit.

12. The battery cooling system of claim 11, wherein a water-cooled condenser is further provided at an upstream point of the radiator.

13. The battery cooling system of claim 7, wherein the switching valve comprises:
a first port connected to a refrigerant inlet side of the battery;
a second port connected to a refrigerant outlet side of the battery;
a third port connected to a refrigerant outlet side of the radiator; and
a fourth port connected to a refrigerant inlet side of the radiator,
wherein the switching valve is configured to switch a state in which the first port and the second port are in communication with each other and the third port and the fourth port are in communication with each other, thereby separating the first cooling circuit and the second cooling circuit from each other, and a state in which the first port and the third port are in communication with each other and the second port and the fourth port are in communication with each other, thereby connecting and integrating the first cooling circuit and the second cooling circuit with each other.

14. The battery cooling system of claim 13, wherein at least one of the first pump that is provided to circulate the refrigerant of the first cooling circuit and the second pump that is provided to circulate the refrigerant of the second pump is formed integrally with the switching valve.

15. The battery cooling system of claim 7, wherein the first cooling circuit and the second cooling circuit are respectively provided with a first pump and a second pump that are configured to circulate the refrigerant.

16. The battery cooling system of claim 15, wherein the first pump provided to circulate the refrigerant of the first cooling circuit is disposed between the switching valve and the battery, and the second pump provided to circulate the refrigerant of the second cooling circuit is disposed between the switching valve and the radiator.

17. A vehicle that comprises the battery cooling system of claim 1.
